(19) United States
(12) Patent Application Publication
(10) Pub. No.: US 2008/0232626 A1
(43) Pub. Date: Sep. 25, 2008

(54) Hearing apparatus with removable volume control module

(76) Inventors: Wai Kit David Ho, Singapore (SG); Wee Haw Koo, Singapore (SG); Beng Hai Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/077,135

(22) Filed: Mar. 17, 2008

(30) Foreign Application Priority Data
Mar. 20, 2007 (DE) 10 2007 013 419.5

(51) Int. Cl. H04R 25/00

(52) U.S. Cl. 381/324

(57) ABSTRACT

A volume control module of a hearing apparatus and specifically a hearing device is to be easily replaceable. A volume control module including a mounting element, specifically a PCB, and including a volume control mounted on the mounting element, is accordingly provided. The mounting element, e.g. the PCB, features at least one fixing recess. A pin element is inserted in the housing recess and in the fixing recess in a form-fit and removable fashion. Thus the volume control module can be removed from the housing once the pin element has been removed from the fixing recess. Secure mounting of the volume control module in the housing, but also at the same time rapid replacement of the volume control module, is thereby possible.

### CROSS REFERENCE TO RELATED APPLICATIONS

This application claims priority of German application No. 10 2007 013 419.5 filed Mar. 20, 2007, which is incorporated by reference herein in its entirety.

### FIELD OF THE INVENTION

The present invention relates to a hearing apparatus having a housing that features at least one housing recess and having a volume control module including a PCB and a volume control mounted on the PCB, with the volume control module being inserted into the housing in a removable fashion. Hearing apparatus is understood here to mean a device that can be worn on the ear e.g. a hearing device, a headset, a set of ear phones and the like.

### BACKGROUND OF THE INVENTION

Hearing devices are wearable hearing apparatuses which assist hard-of-hearing people. In order to accommodate numerous individual requirements, various types of hearing devices are available such as behind-the-ear (BTE) hearing devices and in-the-ear (ITE) hearing devices, for example also concha hearing devices or completely-in-the-canal (CIC) hearing devices. The hearing devices listed as examples are worn on the outer ear or in the auditory canal. Bone conduction hearing aids, implantable or vibro-tactile hearing aids are also available on the market. The damaged hearing is thus stimulated either mechanically or electrically.

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording ambient sound are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or receiver 4, which outputs an acoustic signal. Sound is transmitted to the device wearer's eardrum through a sound tube, which is fixed in the auditory canal by means of an otoplastic. Power for the hearing device and in particular for the signal processing unit 3 is supplied by means of a battery 5 which is also integrated in the hearing device housing 1.

In hearing devices in particular the volume control frequently has to be replaced. In this case an engineer has to open the hearing device housing and desolder the volume control. Next the new volume control must be soldered in and the housing sealed accordingly. This is a time-consuming procedure.

To solve this problem a modular miniature volume control for a hearing device is known from U.S. Pat. No. 5,001,762. The so-called “faceplate” of the hearing device features an aperture for receiving the volume control module. The volume control module can be mounted in a removable fashion on the faceplate and protrudes through said aperture. The volume control can be fastened to the faceplate by means of a snap ring assembly. Cables for the volume control module are to be soldered to corresponding contact tabs of a PCB. However the snap connection may not withstand the strains and once again time-consuming soldering steps may continue to be necessary for the replacement of the volume control module.

### SUMMARY OF THE INVENTION

The object of the present invention is thus to provide a hearing apparatus having a volume control that is solidly attached yet easily replaceable.

This object is inventively achieved by means of a hearing apparatus having a housing that features at least one housing recess and having a volume control module including a mounting element and a volume control mounted on the mounting element, with the volume control module being inserted into the housing in a removable fashion, with the mounting element having at least one fixing recess and with a pin element being inserted in the housing recess and in the fixing recess in a form-fit and removable fashion, such that the volume control module can only be removed from the housing once the pin element has been removed from the fixing recess.

Thus a manufacturer or a service center can advantageously replace the volume control simply by removing the pin element from the housing and/or the hearing apparatus and then by removing the volume control from the housing. In this way a volume control in a different color, for example, can be fitted in a hearing device without the hearing device housing needing to be opened.

During insertion and removal from the housing the volume control module is preferably guided with the aid of the mounting element in a guide in the housing. In this way a stable position on the one hand and a defined insertion motion on the other hand are provided in the hearing apparatus.

In the hearing apparatus according to the invention two pin elements can hold the volume control module in the inserted state in the housing, with strip lines running on the mounting element between both pin elements. Anti-twist protection is also simultaneously realized by the two pin elements, which is particularly advantageous for the strip lines and their contacting.

If the volume control module can be inserted into the housing in one direction of insertion it is further advantageous if the fixing recesses assigned to the two pin elements are arranged on a connecting line at right angles to the direction of insertion. In this way it is sufficient if the recesses for example are merely semi-circular in shape and if the volume control module also cannot then be removed by means of a rotary motion between the pin elements.

It is additionally advantageous if the mounting element is a PCB and if the longitudinal axis of the at least one pin element runs perpendicularly to the PCB in the inserted state. Optimum stability of the PCB is thus guaranteed if the volume control module is inserted into the housing at the plane of the PCB.

For electrical contacting of the volume control module at least one spring contact of an electronic device of the hearing apparatus can contact one strip line of the PCB in the inserted state of the volume control module. Such spring contacts thus obviate the need for soldered connections.

It is further advantageous if in the inserted state of the volume control module the at least one spring contact protrudes between the two pin elements. In this way reliable contacting of the strip lines can be realized as the PCB of the volume control module has practically no play between the pin elements.

### BRIEF DESCRIPTION OF THE DRAWINGS

The present invention is now described in more detail with reference to the appended drawings, in which

FIG. 1 shows the basic configuration of a hearing device according to the prior art;

FIG. 2 shows a perspective view of a volume control module according to the invention;

FIG. 3 shows the volume control module from FIG. 2 with pins removed;

FIG. 4 shows the volume control module from FIG. 3 in a removed status;

FIG. 5 shows a replaced volume control module for insertion; and

FIG. 6 shows the replaced volume control module in the inserted state before the pins are pushed in.

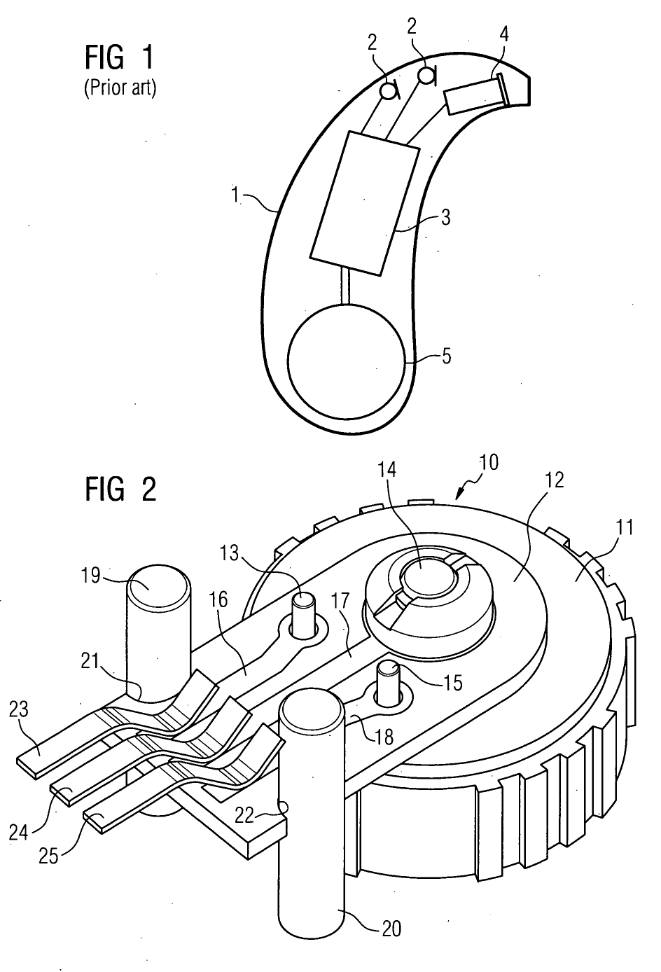

### DETAILED DESCRIPTION OF THE INVENTION

The exemplary embodiment shown in more detail below represents a preferred embodiment of the present invention.

FIG. 2 shows a volume control module 10 with an adjusting wheel 11 in which a potentiometer (not shown) is located. The adjusting wheel 11 and/or the potentiometer is mounted rotatably on a small PCB 12 that serves as a mounting and conductor element. The potentiometer has three electrical contacts 13, 14 and 15 that are connected electrically to corresponding strip lines 16, 17 and 18 that run on the PCB 12.

In this example the volume control module 10 comprises the PCB 12 and the potentiometer with adjusting wheel 11. However the volume control module can alternatively also be realized with linear actuators or switches.

FIG. 2 shows the volume control module 10 in an inserted state in a housing, whereby the housing itself is not shown. Instead merely two cylindrical fixing pins 19, 20 are shown that engage in a form-fit manner with semi-circular recesses 21, 22 in the PCB 12. The two fixing pins 19 and 20 are positioned perpendicularly to the plane of the PCB 12. The strip lines 16, 17 and 18 run between them, said strip lines being contacted by spring contacts 23, 24, 25 that are designed as curved bifurcated contact tongues.

The fixing pins 19, 20 are held in the hearing device housing in corresponding drilled holes. They can be pushed out of these drilled holes along their longitudinal axis without the hearing device housing needing to be opened. However since in the inserted state they engage in a form-fit manner with the PCB 12, as shown in FIG. 2, the PCB 12 and/or the entire volume control module 10 cannot be moved at the plane of the PCB 12. Thus the volume control module 10 is fixed in a removable fashion in the hearing device housing.

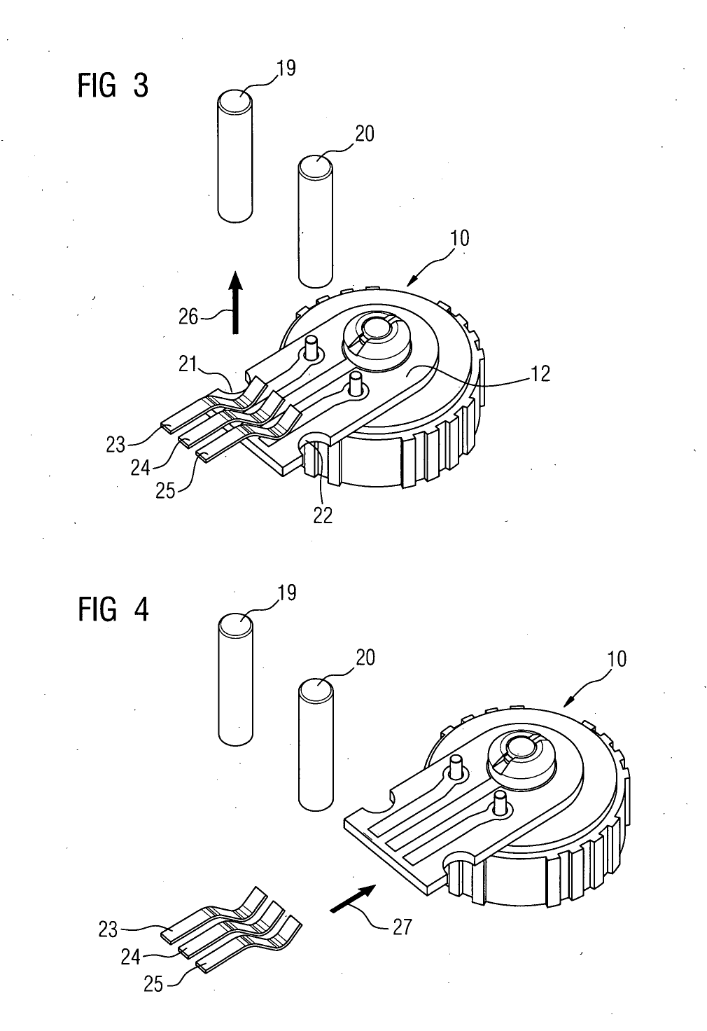

FIGS. 3 to 6 show how a volume control module according to the invention can be replaced. FIG. 3 shows the same volume control module 10 as was shown in FIG. 2. According to the arrow 26 however the two fixing pins 19, 20 are removed from the housing and/or from the recesses 21, 22 according to the arrow 26. The volume control module 10 is now movable along the PCB 12. FIG. 4 shows by means of the arrow 27 that the volume control module 10 has been removed from the housing.

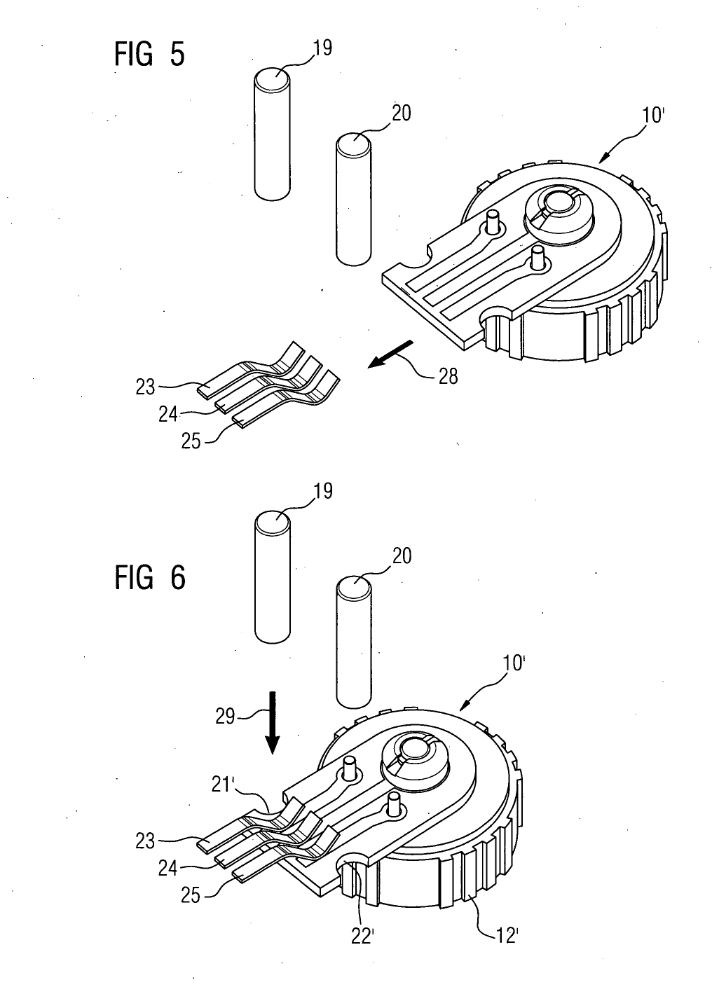

The volume control module 10 is now replaced by a volume control module 10′ and according to FIG. 5 is reinserted into the hearing device housing as symbolized by the arrow 28. In the inserted state the spring contact tongues 23, 24 and 25 of the hearing device electronics contact the strip lines of the volume control module 10′. According to FIG. 6 in the final mounting step the fixing pins 19 and 20 are now reinserted into the hearing device housing i.e. into its drilled holes as indicated by arrow 29. They engage with the recesses 21′, 22′ of the PCB 12′ of the newly inserted volume control module 10′. Thus the newly inserted volume control module 10′ is again fixed in the hearing device housing. Replacing the volume control module therefore requires no soldering and in particular also requires no special tool. The fixing pins for the volume control module must simply be temporarily removed and reinserted.

1.-7. (canceled)

8. A hearing apparatus, comprising:
a housing comprising a housing recess;
a volume control device that is inserted into the housing at an inserted position;
a mounting unit arranged on the volume control device comprising a fixing recess; and
a pin that is inserted into the housing recess and the fixing recess so that the volume control device is removed from the housing when the pin has been removed from the fixing recess.

9. The hearing apparatus as claimed in claim 8, wherein the pin is form-fitly inserted into the housing recess and the fixing recess.

10. The hearing apparatus as claimed in claim 8, wherein the volume control device is guided by the mounting unit in a guide of the housing during inserting into and removing from the housing.

11. The hearing apparatus as claimed in claim 8, wherein the mounting unit is a PCB and perpendicular to a longitudinal axis of the pin at the inserted position.

12. The hearing apparatus as claimed in claim 8, wherein the volume control device is held by two pins at the inserted position.

13. The hearing apparatus as claimed in claim 12, wherein strip lines are arranged between the two pins.

14. The hearing apparatus as claimed in claim 12, wherein the volume control device is inserted into the housing in a direction perpendicular to a line connecting the two pins.

15. The hearing apparatus as claimed in claim 12, wherein a spring contact of an electronic device of the hearing apparatus contacts a strip line of the mounting unit at the inserted position.

16. The hearing apparatus as claimed in claim 15, wherein the spring contact protrudes between the two pins at the inserted position.

17. A method for removing a volume control device from a housing of a hearing apparatus, comprising:
providing a housing recess on the housing;
inserting the volume control device into the housing;
arranging a mounting unit on the volume control device comprising a fixing recess;
inserting a pin into the housing recess and the fixing recess;
removing the pin from the fixing recess; and
removing the volume control device from the housing after removing the pin.

18. The method as claimed in claim 17, wherein the pin is form-fitly inserted into the housing recess and the fixing recess.
